(19) United States
(12) Patent Application Publication
(10) Pub. No.: US 2013/0062879 A1
(43) Pub. Date: Mar. 14, 2013

(54) INFLATING HOSE CONNECTOR

(71) Applicant: Lopin WANG, Taichung City (TW)

(72) Inventor: Lopin WANG, Taichung City (TW)

(21) Appl. No.: 13/550,873

(22) Filed: Jul. 17, 2012

(30) Foreign Application Priority Data
Sep. 9, 2011 (TW) 100217008

(51) Int. Cl. F16L 21/035; F16L 33/18

(52) U.S. Cl. 285/347

(57) ABSTRACT

An inflating hose connector includes a plug defining a plug body for insertion into one end of an inflating hose and a head at one end of the plug body, a locknut rotatably capped on the plug head, a connection member defining an outer thread on each of two opposing ends thereof for selectively fastening to the locknut, a Schrader (American) valve connection hole in one end thereof and a Schrader (American) valve connection hole in the other end thereof. Thus, the user can freely select a Schrader (American) valve or a Presta (French) valve, and fasten up the inflating hose connector with the selected Schrader (American) or Presta (French) valve conveniently by means of a screw joint, preventing loosening and facilitating application.

### BACKGROUND OF THE INVENTION

1. Field of the Invention

The present invention relates inflating devices and more particularly, to an inflating hose connector, which is selectively set between two modes for Schrader (American) valve or Schrader (American) valve application.

2. Description of the Related Art

Conventional dual purpose inflating hose connectors selectable for Schrader (American) valve or Schrader (American) valve application commonly have a complicated structure and large size, and are not convenient to use. For example, a known inflating hose connector comprises two connection holes arranged in a parallel manner on the connector body, and a handle for controlling the connection status between the connector and the valve. This structure can easily be loosened. Further, rotating the handle requires a large space. It is inconvenient to operate the handle of this design of inflating hose connector in a narrow space.

### SUMMARY OF THE INVENTION

The present invention has been accomplished under the circumstances in view. It is the main object of the present invention to provide an inflating hose connector, which has a compact structural design, facilitating operation and saving much installation space.

To achieve this and other objects of the present invention, an inflating hose connector comprises a plug, which is an elongated member comprising a plug body for insertion into one end of an inflating hose and a head disposed at one end of the plug body, a locknut, which is rotatably capped on the plug head, and a connection member, which defines an outer thread on each of two opposing ends thereof for selectively fastening to the locknut. Further, the connection member has a Schrader (American) valve connection hole formed in one end thereof and a Schrader (American) valve connection hole formed in the other end thereof Thus, the user can freely select a Schrader (American) valve or a Presta (French) valve, and fasten up the inflating hose connector with the selected Schrader (American) or Presta (French) valve conveniently by means of a screw joint. Thus, this design of inflating hose connector has a simple structure and is easy and convenient to use.

### BRIEF DESCRIPTION OF THE DRAWINGS

FIG. 1 is a front assembly view of an inflating hose connector in accordance with the present invention.

FIG. 2 is an exploded view of the inflating hose connector in accordance with the present invention.

FIG. 3 is a schematic sectional assembly view of the present invention, illustrating the inflating hose connector arranged in a first mode for Schrader (American) valve application.

FIG. 4 is a schematic sectional assembly view of the present invention, illustrating the inflating hose connector arranged in a second mode for Presta (French) valve application.

### DETAILED DESCRIPTION OF THE INVENTION

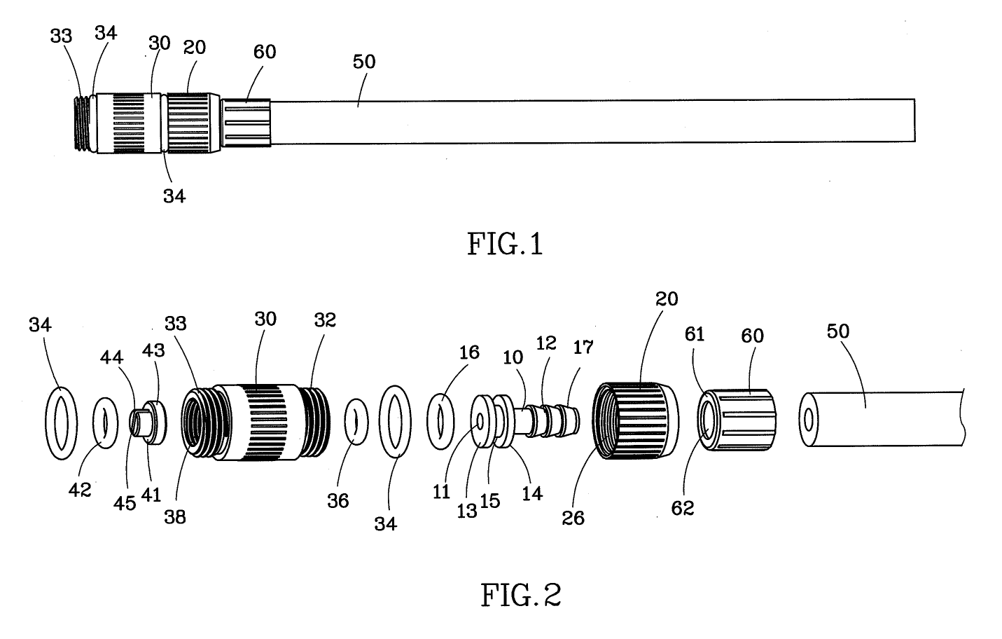

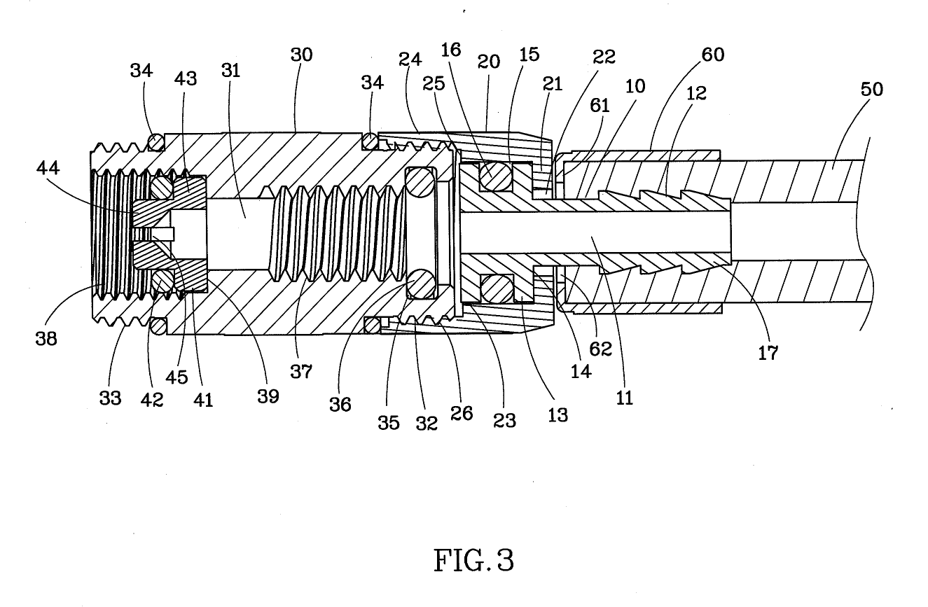

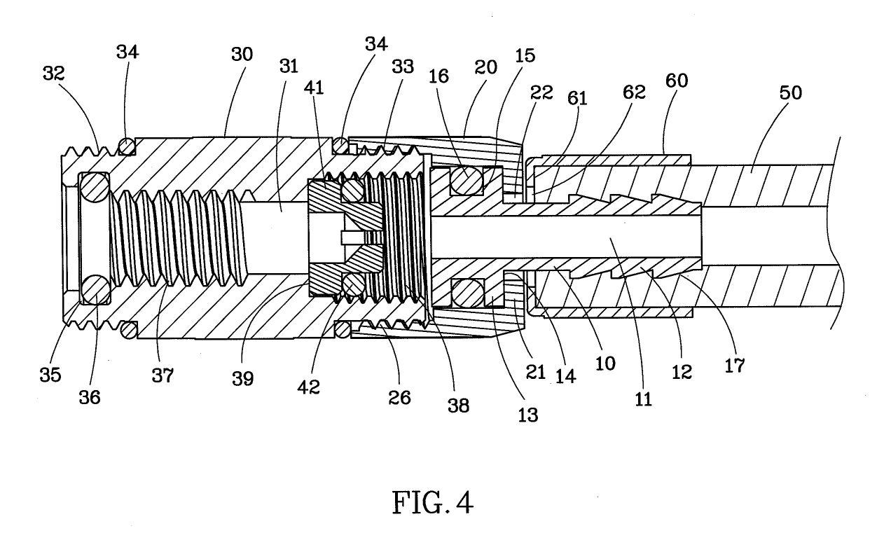

The advantages and features of the present invention will be fully understood by way of examples in conjunction with the annexed drawing of FIGS. 1-4.

As illustrated, the inflating hose connector comprises:

a plug 10 that is an elongated member comprising a plug head 13 located on a front end thereof, a rod-like plug body 12 located on an opposite rear end thereof and plugged into one end of an inflating hose 50 of a high-pressure air source (not shown), a shoulder face 14 defined between the plug head 13 and the plug body 12, an axial hole 11 axially extending through the center of the plug head 13, shoulder face 14 and plug body 12, a locating groove 15 extending around the periphery of the plug head 13, an O-ring 16 fastened to the locating groove 15, and at least one, for example, three barbed portions 17 located on the periphery of the plug body 12 that facilitate insertion of the plug body 12 into the inflating hose 50 and enhance positive positioning of the plug body 12 in the inflating hose 50;

a locknut 20 that is shaped like an open-end cap, comprising a shoulder 21 located at one end thereof for stopping against the shoulder face 14 of the plug 10 to secure the plug 10 to the locknut 20, a through hole 22 cut through the center of the shoulder 21 for the passing of the plug body 12 of the plug 10 for allowing rotation of the plug 10 relative to the locknut 20 and having a diameter slightly greater than the outer diameter of the plug body 12 of the plug 10, a coupling portion 23 located in the middle thereof and having an inner diameter slightly greater than the outer diameter of the plug head 13 of the plug 10 so that the plug head 13 of the plug 10 can be accommodated in the coupling portion 23 and the O-ring 16 can be stopped against the inside wall of the coupling portion 23 to seal the gap between the plug head 13 and the coupling portion 23, a connection portion 24 located at an opposite end thereof and having an inner diameter greater than the inner diameter of the coupling portion 23, a shoulder face 25 defined between the connection portion 24 and the coupling portion 23, and an inner thread 26 extending around the inside wall of the connection portion 24;

a connection member 30 that is a cylindrical member comprising an axial hole 31 axially extending through the two opposing ends thereof at the center, two externally threaded connection portions 32 and 33 respectively located at the two opposing ends and selectively connectable with the inner thread 26 of the connection portion 24 of the locknut 20, an O-ring 34 mounted on each of the externally threaded connection portions 32 and 33 for stopping against one end of the locknut 20 remote from the shoulder 21 to seal the gap between the connection member 30 and the locknut 20, an inside annular groove 35 disposed in one end of the axial hole 31, an O-ring 36 mounted in the inside annular groove 35, an inner thread 37 disposed in the axial hole 31 adjacent to the O-ring 36 in the inside annular groove 35 and workable with the O-ring 36 for connection with a Presta (French) valve, an internally threaded connection portion 38 formed integral with the other end of the axial hole 31 and having an inner diameter greater than the axial hole 31, and a shoulder face 39 defined between the internally threaded connection portion 38 and the axial hole 31;

a thimble 41 mounted in the internally threaded connection portion 38 of the connection member 30 and stopped against the shoulder face 39; and

a seal ring 42 mounted on the outside of the thimble 41.

The internally threaded connection portion 38 of the connection member 30, the seal ring 42 and the thimble 41 are adapted for connection with a Schrader (American) valve.

Further, the thimble 41 comprises an annular base 43, a needle portion 44 extended from one side of the annular base 43, and a through hole 45 on the center of the needle portion 45. The seal ring 42 is supported on the annular base 43 around the needle portion 44. The thimble 41 is adapted for push open the gate of a Schrader (American) valve.

During application, one of the two externally threaded connection portions 32 and 33 is selected and connected with the inner thread 26 of the connection portion 24 of the locknut 20 for Schrader (American) valve or Presta (French) valve application. Because the locknut 20 can be rotated relative to the plug 10, the inflating hose connector is rotatable relative to the inflating hose 50. Thus, the assembled inflating hose connector can be fastened up with the Schrader (American) valve or Presta (French) valve conveniently. This design of inflating hose connector has a compact structure, saving installation space.

Further, in order to prevent excessive friction between the inflating hose connector and the inflating hose 50 upon rotation of the inflating hose connector relative to the inflating hose 50, an end cap 60 is used. The end cap 60 is capped on one end of the inflating hose 50, having a shoulder 61 located on one end thereof and stopped against the end edge of the respective end of the inflating hose 50, and a through hole 62 located on the center of the shoulder 61 for the passing of the plug body 12 of the plug 10.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An inflating hose connector, comprising:
a plug comprising a plug head located on a front end thereof, a rod-like plug body located on an opposite rear end thereof and plugged into a free end of an inflating hose of a high-pressure air source, a shoulder face defined between said plug head and said plug body, an axial hole axially extending through the center of said plug head, said shoulder face and said plug body of said plug, a locating groove extending around the periphery of said plug head, and an O-ring fastened to said locating groove;
a locknut comprising a shoulder located at one end thereof for stopping against the shoulder face of said plug, a through hole cut through the center of the shoulder of said locknut for the passing of said plug body of said plug and having a diameter slightly greater than the outer diameter of said plug body of said plug, a coupling portion located in a middle part thereof and having an inner diameter slightly greater than the outer diameter of said plug head of said plug for allowing said plug head of said plug to be accommodated in said coupling portion and the O-ring of said plug to be stopped against an inside wall of said coupling portion to seal the gap between said plug head and said coupling portion, a connection portion located at an opposite end thereof and having an inner diameter greater than the inner diameter of said coupling portion, a shoulder face defined between the connection portion and coupling portion of said locknut, and an inner thread extending around an inside wall of said connection portion;
a connection member comprising an axial hole axially extending through the two opposing ends thereof at the center, two externally threaded connection portions respectively located at the two opposing ends and selectively connectable with the inner thread of said connection portion of said locknut, an inside annular groove disposed in one end of the axial hole of said connection member, an O-ring mounted in said inside annular groove, an inner thread disposed in the axial hole of said connection member adjacent to the O-ring in said inside annular groove and workable with the O-ring for connection with a Presta (French) valve, an internally threaded connection portion formed integral with an opposite end of the axial hole of said connection member and having an inner diameter greater than the axial hole of said connection member, and a shoulder face defined between said internally threaded connection portion and the axial hole of said connection member;
a thimble mounted in said internally threaded connection portion of said connection member and stopped against the shoulder face of said connection member; and
a seal ring mounted on said thimble and workable with said internally threaded connection portion of said connection member and said thimble for connection with a Schrader (American) valve.

2. The inflating hose connector as claimed in claim 1, further comprising an O-ring mounted on each of said externally threaded connection portions of said connection member for stopping against one end of said locknut remote from said shoulder.

3. The inflating hose connector as claimed in claim 1, wherein said thimble comprises an annular base, a needle portion extended from one side of said annular base, and a through hole extending through the center of said needle portion; said seal ring is supported on said annular base of said thimble around said needle portion.

4. The inflating hose connector as claimed in claim 1, further comprising an end cap capped on the free end of said inflating hose, said end cap comprising a shoulder located on one end thereof and stopped against an end edge of said free end of said inflating hose, and a through hole located on the center of the shoulder of said end cap for the passing of said plug body of said plug.
